(19) United States
(12) Patent Application Publication
(10) Pub. No.: US 2007/0202250 A1
(43) Pub. Date: Aug. 30, 2007

(54) LIGHT GUIDE PLATE AND MANUFACTURING METHOD OF LIGHT GUIDE PLATE PATTERN

(76) Inventors: Jun-Sheng Lin, Chang-Hua Hsien (TW); Chuan-Pei Yu, I-Lan Hsien (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/382,066

(22) Filed: May 8, 2006

(30) Foreign Application Priority Data
Feb. 24, 2006 (TW) 095106417

(51) Int. Cl. B05D 5/06; B05D 5/00

(52) U.S. Cl. 427/162; 427/256

(57) ABSTRACT

A manufacturing method of light guide plate pattern includes performing a dispensing process or an inkjet process to form a plurality of protrudent dot patterns on a light guide plate with a smooth surface, and solidifying the dot patterns.

### BACKGROUND OF THE INVENTION

1. Field of the Invention

The present invention relates to a light guide plate and a manufacturing method thereof, and more particularly, to a manufacturing method of a light guide plate utilizing a surface pattern treatment process.

2. Description of the Prior Art

A backlight module is one of the most important components of a liquid crystal display (LCD), which is widely used in digital cameras, mobile phones, personal digital assistants (PDA), computer monitors, and flat panel televisions. In general, a backlight module is installed behind a display panel and includes a light source generator, a light guide plate, a reflecting sheet, a diffusion sheet, and a few types of optical films or prism sheets.

The function of the light guide plate is to guide the scattering direction of the light generated by the light source generator to increase luminance of the display panel, and ensure uniform brightness of the display panel to transform a point light source or a linear light source of the backlight module into a planar light source for the LCD panel. Therefore, material property of the light guide plate, design and manufacturing of the surface diffusion pattern are related to optical design and control of the luminance and mura of the backlight module, and the material property of the light guide plate, design and manufacturing of the surface diffusion pattern are major considerations and costs of the backlight module manufacturers. In general, the light guide plate is manufactured with injection molding method by making acryl into a planar plate or a wedge-shaped plate, and the surface diffusion pattern of the light guide plate is formed at the same time in the injection molding process. In the backlight module, when the light generated by the light source generator enters into the light guide plate and hits the diffusion pattern, the light will be diffused to every direction when it is reflected by the diffusion pattern, and thus, different spacing and size of the diffusion pattern design can be utilized to make the light guide plate surface light uniformly.

Please refer to FIG. 1. FIG. 1 is a flowchart of a prior art method of developing and designing a light guide plate pattern. In general, when a new product is optically improved or developed and designed, the light guide plate pattern is often modified and tested for a few times to attain an optimal optical effect of the backlight module. Therefore, when developing a product or designing a light guide plate, a plurality of light guide plates with different light guide plate patterns must be manufactured. At this time, a key point of product development is whether it is possible to manufacture a plurality of light guide plates with different light guide plate patterns efficiently. As shown in FIG. 1, a flowchart of a prior art method of manufacturing a light guide plate by injection molding method is as follows.

Step 101: Design a light guide plate pattern according to the developing product first, and the designing time is about 3 hours, and then go to step 103;

Step 103: Manufacture a negative with the light guide plate pattern according to the light guide plate pattern designed in step 101, and the manufacturing time of the negative is about 1 day, and then go to step 105;

Step 105: Manufacture an insert mold of an injection mold by lithography and etching with the negative manufactured in step 103, wherein the light guide plate pattern is micro structure pattern, and thus the manufacturing time of the insert mold is about 4 days, and then go to step 107;

Step 107: Position the insert mold manufactured in step 105 into the injection mold to manufacture a light guide plate by injection molding process, and the manufacturing time is about 1 day, and then go to step 109;

Step 109: Assemble the light guide plate and other optical components to be a backlight module, and the assembling time is about 2 hours, and then go to step 111;

Step 111: Perform an optical test process for the backlight module assembled in step 109, and each testing time is about 1 hour; when the optical test process result is good or qualified, step 113 is performed to finish the light guide plate design, and when the optical test process result is not good or not qualified, steps 101 to 111 are repeated to design the light guide plate pattern, manufacture the negative and the insert mold, perform the injection molding process, assemble the backlight module, and perform the optical test process again;

Step 113: End.

Accordingly, when manufacturing a light guide plate by utilizing the prior art method, the product development period of each light guide plate version is about 6 to 7 days, and it results in problems of long development period and no efficiency. In addition, when designing and manufacturing a light guide plate pattern every time in the prior art, a corresponding insert mold must be manufactured, and thus a considerable cost of the mold must be spent during the product development period.

As mentioned above, how to design and manufacture the light guide plate by a method of low cost and high efficiency in order to save cost and time of the product development is still an important issue for the backlight module manufacturers.

### SUMMARY OF THE INVENTION

A primary objective of the present invention is to provide a method of performing a protrudent dot treatment process on a light guide plate surface to manufacture the light guide plate, and utilizing the light guide plate manufactured by the method to resolve the problems of wasting time and high cost in the prior art method mentioned above.

According to the present invention, a method of designing a light guide plate pattern of a backlight module is disclosed, and the method comprises following steps, designing a light guide plate pattern comprising a plurality of protrudent dot patterns, providing at least a blank light guide plate with a smooth surface, progressing a protrudent dot treatment process on the light guide plate surface according to the light guide plate pattern, and the protrudent dot treatment process using a protrudent dot processing device filled with a protrudent dot material to sequentially form the protrudent dot patterns on the light guide plate surface individually by utilizing the protrudent dot material, assembling the light guide plate in the backlight module, and progressing an optical test process, wherein if the optical test process result is good, then finish designing the light guide plate pattern of the backlight module, and if the optical test process result is not good, then repeat steps mentioned above.

In addition, according to the present invention, the protrudent dot treatment process is preferably a dispensing process or an inkjet process to form the protrudent dot patterns on the blank light guide plate surface individually in sequence.

Since the present invention utilizes the protrudent dot treatment process, which is less time-consuming and low cost, to form the light guide plate pattern, when designing the light guide plate pattern, a plurality of light guide plates with different surface patterns can be manufactured in a shorter period to efficiently perform an integral design of the light guide plate pattern and the backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a prior art method of developing and designing a light guide plate pattern.

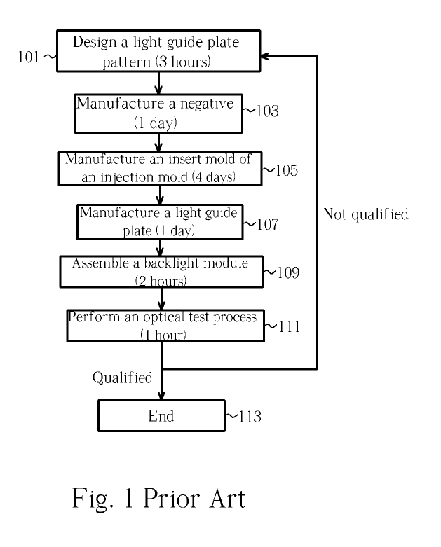

FIG. 2 is a flowchart of a method of designing and manufacturing a light guide plate pattern according to the present invention.

FIG. 3 is a diagram of a light guide plate pattern designed in step 201 of the flowchart shown in FIG. 2.

FIG. 4 is a diagram of performing a protrudent dot treatment process in the present invention.

FIG. 5 is an enlarged diagram of the surface-roughening process for the protrudent dot patterns in the present invention.

FIG. 6 is an enlarged diagram of the surface-roughening process for the protrudent dot patterns in the present invention.

### DETAILED DESCRIPTION

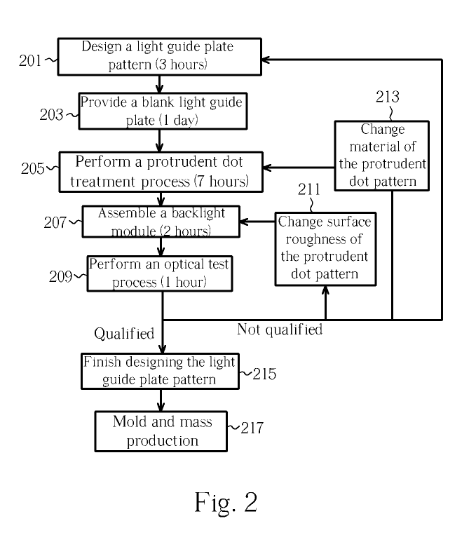

Please refer to FIG. 2. FIG. 2 is a flowchart of a method of designing and manufacturing a light guide plate pattern according to the present invention. In the present invention, the light guide plate is applied in a flat display such as a LCD. According to the present invention, a flowchart of the method of designing and manufacturing a light guide plate pattern is as follows.

Step 201: According to the developing product, design a light guide plate pattern comprising plurality of protrudent dot patterns, and the designing time is about 3 hours, and then go to step 203;

Step 203: Provide at least a blank light guide plate with a smooth surface, wherein the blank light guide plate can be manufactured by injection molding process, and the manufacturing time of the blank light guide plate is about 1 day, and then go to step 205;

Step 205: Perform a protrudent dot treatment process on the blank light guide plate surface according to the light guide plate pattern designed in step 201. The protrudent dot treatment process involves using a protrudent dot processing device filled with a protrudent dot material to sequentially form each protrudent dot pattern on the blank light guide plate surface individually, and then solidify each protrudent dot pattern, and the protrudent dot treatment process takes about 7 hours, and then go to step 207;

Step 207: Assemble the light guide plate and other optical components to be a backlight module, and the assembling time is about 2 hours, and then go to step 209;

Step 209: Perform an optical test process for the backlight module assembled in step 207, and each testing time is about 1 hour; when the optical test process result is good or qualified, then step 215 is performed to finish the light guide plate design, and when the optical test process result is not good or not qualified, then repeat steps 201 to 209 to design the light guide plate pattern, perform the protrudent dot treatment process, assemble the backlight module, and perform optical test process again, or perform steps 211 to 209 or steps 213 to 209;

Step 211: Directly design and change surface roughness of the protrudent dot pattern, and perform a surface-roughening process for the protrudent dot pattern to improve integral optical effect of the light guide plate, and then go to step 207;

Step 213: Directly design and change material of the protrudent dot pattern, and improve integral optical effect of the light guide plate by changing the material and refractive index or light guiding property, and then go to step 205;

Step 215: Finish designing the light guide plate pattern, and if the product is in mass production, then go to step 217;

Step 217: When the light guide plate is in mass production, the developed injection molding process is able to be chosen to form the light guide plate pattern passing the optical test on a mold, and mass produce the light guide plate, and therefore, only one injection mold is required to mass produce the light guide plate efficiently.

As mentioned above, the development period of designing the light guide plate pattern in the present invention is about 4 days, and therefore the product development efficiency is increased and designing cost is saved substantially. In addition, multiple blank light guide plates can be prepared in step 203, and thus when the light guide plate pattern must be designed again due to bad optical test results, step 203 can be ignored and the development period is further saved.

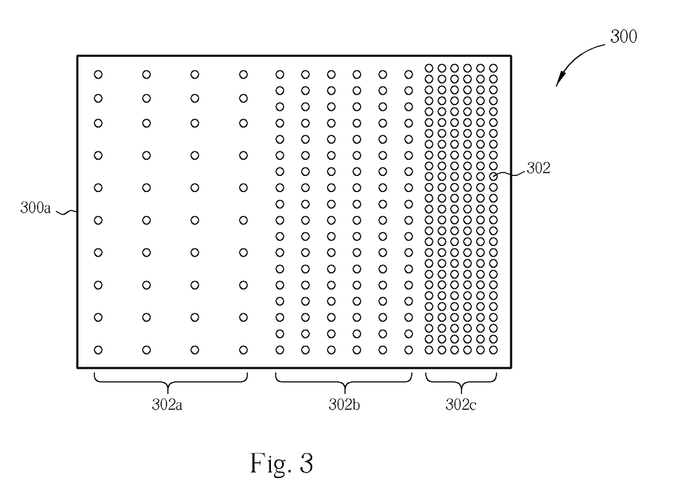

A detailed illustration for each step of the method according to the present invention is as follows. Please refer to FIG. 3. FIG. 3 is a diagram of a light guide plate pattern 300 designed in step 201. In the light guide plate pattern 300, one side of the light guide plate is a light-exit face 300a, and the light guide plate pattern 300 comprises a plurality of protrudent dot patterns 302. In general, when designing the light guide plate pattern 300, the density of the protrudent dot patterns 302 far from the light-exit face 300a will be bigger than the density of the protrudent dot patterns 302 near the light-exit face 300a, as shown in FIG. 3.

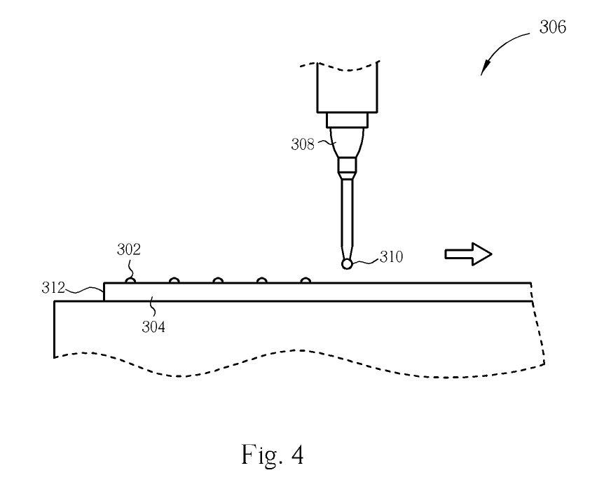

Please refer to FIG. 4. FIG. 4 is a diagram of performing a protrudent dot treatment process in the present invention. FIG. 4 shows that a blank light guide plate 304 provided in step 203 is positioned on a protrudent dot treatment processing device 306. The protrudent dot treatment process can be an inkjet process or a dispensing process, and thus the protrudent dot treatment processing device can comprise a sprinkling nozzle or a dispensing machine. FIG. 4 shows a dispensing needle head 308 filled with a protrudent dot material 310 to perform a dispensing process. Therefore, when performing the dispensing process, the dispensing needle head 308 (or a sprinkling nozzle of an inkjet machine) is utilized to form a plurality of protrudent dot patterns. For example, after forming the protrudent dot patterns on the blank light guide plate 304 in sequence, the dispensing needle head 308 is moved in the direction of the arrowhead to form the next row of the protrudent dot patterns. In this way, the dispensing needle head 308 will be moved to every decided position of the protrudent dot patterns in sequence in order to coat the protrudent dot material 310 on the surface of the blank light guide plate 304 to form the protrudent dot patterns 302. In the present invention, the blank light guide plate 304 also can be moved by the protrudent dot treatment processing device to let the dispensing needle head 308 form the protrudent dot patterns in every decided position of the protrudent dot patterns. The protrudent dot material 310 can comprise photosensitive resin or ink, for example, an ultraviolet (UV) resin. Thus, after the protrudent dot patterns 302 is formed, a solidifying process can be performed by irradiating the protrudent dot patterns 302 in order to finish manufacturing the light guide plate 312.

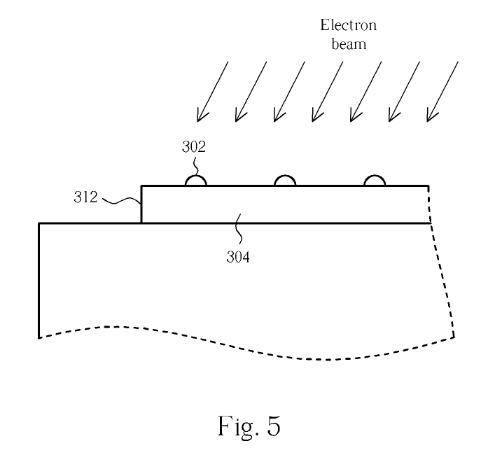

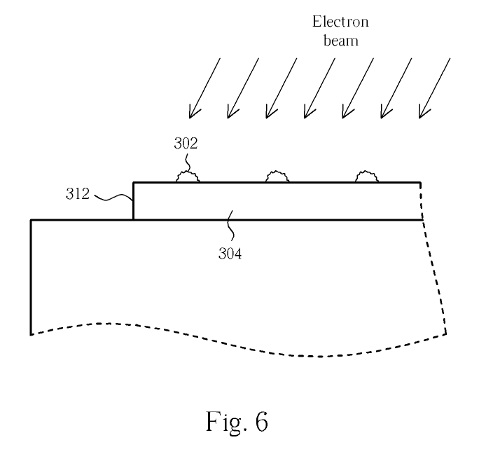

In addition, the protrudent dot treatment process can further comprise a surface-roughening process for the protrudent dot patterns optionally. Please refer to FIG. 5 and FIG. 6. FIG. 5 and FIG. 6 are enlarged diagrams of the surface-roughening process for the protrudent dot patterns in the present invention. As shown in FIG. 5, the surface-roughening process provides a variation of energy or temperature for the protrudent dot patterns 302, in order to destroy surface tension of the protrudent dot patterns by raising temperature to achieve softening point of the protrudent dot material 310, and then roughening the surface of the protrudent dot patterns 302 by shrinking the protrudent dot material 310 when it is cooled down as shown in FIG. 6. The surface-roughening process mentioned above can be realized by a few methods such as a sputtering process or a heating process, wherein the sputtering process uses an electron beam with energy to hit the protrudent dot patterns 302 and change shape of the protrudent dot patterns 302, and the heating process heats the light guide plate 312 rapidly and then cools down the light guide plate 312 rapidly in order to attain the objective of surface-roughening the protrudent dot patterns 302.

Furthermore, when the optical test process result is not good in step 209 and the light guide plate pattern 300 is required to be designed again, the light guide plate pattern 300 can be changed or re-designed. This can include, for example, changing distribution and size of the protrudent dot patterns 302, or directly changing material or surface rougheness of the protrudent dot patterns 302 such as utilizing the protrudent dot material 310 with different refractive index or surface-roughening the protrudent dot patterns 302, and in this way, the objective of improving optical effect of the light guide plate 312 can be achieved without designing the light guide plate pattern 300 again. Please refer to FIG. 3 again for an illustration about how to change the protrudent dot material 310. When adjusting the size of the protrudent dot material 310 or the protrudent dot patterns 302, the light guide plate can be divided into a plurality of bright areas and dark areas according to the optical test result in order to make the protrudent dot patterns 302 in dark areas be denser, and to make the surface of the protrudent dot material 310 rougher, to let light emit to the light-exit face more easily. In FIG. 3, supposing the area is darker when farther from the light-exit face 300a, the area can be divided into a first pattern 302a, a second pattern 302b, and a third pattern 302c according to the difference between the dark areas and the bright areas, and the protrudent dot patterns 302 of the first pattern 302a, the second pattern 302b, and the third pattern 302c possess different size and distribution density. For example, the third pattern 302c possesses the biggest distribution density, and the surface is rougher. Therefore, when forming the protrudent dot patterns 302 by the inkjet process or the dispensing process, the protrudent dot patterns 302 with the same protrudent dot material 310 or the same size, for example, the first pattern 302a, can be formed first, and then a process parameter adjustment is performed for the protrudent dot treatment processing device 306 such as changing size of the dispensing needle head 308 or changing the dispensing pressure and time, in order to form the second pattern 302b. After the second pattern 302b is formed, perform the process parameter adjustment again according to requirement the third pattern 302c to form the third pattern 302c. In addition, when forming the protrudent dot patterns 302 by the inkjet process, some of the sprinkling nozzles are able to directly form the protrudent dot patterns 302 with different sizes on the surface of the blank light guide plate 304. Therefore, if the first pattern 302a, the second pattern 302b, and the third pattern 302c are only different in pattern design such as the distribution density or the size, the protrudent dot patterns 302 can be formed in sequence by the parameter adjustment in the inkjet process, and the sprinkling nozzle or the protrudent dot material 310 is not required to be changed.

Therefore in the present invention, the protrudent dot patterns with different refractive indexes can be formed on the different light guide plates by replacing the protrudent dot material in the protrudent dot processing device, and different optical effects are obtained through different refractive indexes. Furthermore, probability of refraction and scattering also can be increased by changing the roughness of the protrudent dot surface through heating of the electron beam. According to the Snell's law, the light will change path in the material with different refractive index, and the total reflection occurs more easily when the light goes from a material with bigger refractive index into the interface between the material and air. The present invention utilizes this property to obtain different light conducting effects by changing the refractive index or the roughness of the protrudent dot pattern. For example, when the optical test result shows that the backlight module has a dark area in the third pattern 302c, a protrudent dot material with bigger refractive index can be utilized according to the original pattern without changing the light guide plate pattern, in order to strengthen the positive (moving forward to the light-exit face of the light guide plate) luminance, or a surface-roughening process can be performed on the protrudent dot pattern of the dark area to destroy the total reflection, and thus the time of re-designing the light guide plate pattern can be saved.

Compared with the prior art, the method of forming the light guide plate pattern on the blank light guide plate according to the present invention requires an extremely short process period, hence the present invention provides a great contribution for increasing efficiency in the product development and decreasing the cost. Furthermore, the protrudent dot pattern of the light guide plate according to the present invention can possess different refractive indexes to directly improve the light conducting effect, or a surface-roughening process can be performed on the protrudent dot pattern to destroy the total reflection, and the present invention is contributive in breaking current bottlenecks of the light guide plate pattern development and design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of designing a light guide plate pattern of a backlight module, comprising following steps:
(a) designing a light guide plate pattern, comprising a plurality of protrudent dot patterns;
(b) providing at least a blank light guide plate with a smooth surface;
(c) progressing a protrudent dot treatment process on the light guide plate surface according to the light guide plate pattern, and the protrudent dot treatment process using a protrudent dot processing device filled with a protrudent dot material to sequentially form the protrudent dot patterns on the light guide plate surface individually by utilizing the protrudent dot material;
(d) assembling the light guide plate in the backlight module; and
(e) progressing an optical test process, wherein if the optical test process result is good, then finish designing the light guide plate pattern of the backlight module, and if the optical test process result is not good, then repeat steps (b) to (e).

2. The method of claim 1, wherein the protrudent dot treatment process is a dispensing process, and the protrudent dot treatment processing device is a dispensing machine.

3. The method of claim 1, wherein the protrudent dot treatment process is an inkjet process, and the protrudent dot processing device comprises a sprinkling nozzle; when forming each of the protrudent dot patterns, the sprinkling nozzle is utilized to directly sprinkle the protrudent dot material on the light guide plate surface to form the protrudent dot pattern.

4. The method of claim 1, wherein protrudent dot materials with various indexes of refraction are utilized to form the protrudent dot patterns with various indexes of refraction on the different blank light guide plates when progressing the protrudent dot treatment process.

5. The method of claim 1, wherein the protrudent dot materials comprises photosensitive resin or ink.

6. The method of claim 1, wherein the protrudent dot treatment process further comprises progressing a solidifying process for the protrudent dot patterns after the protrudent dot patterns are formed.

7. The method of claim 1, wherein the protrudent dot treatment process further comprises progressing a surface-roughening process for the protrudent dot patterns after the protrudent dot patterns are formed.

8. The method of claim 7, wherein the surface-roughening process provides a variation of energy or temperature for the protrudent dot patterns to destroy surface tension of the protrudent dot patterns.

9. The method of claim 7, wherein the surface-roughening process comprises a sputtering process or a heating process.

10. The method of claim 1, wherein the method further comprises a molding process for the light guide plate pattern after designing the light guide plate pattern of the backlight module is finished.

11. A method of manufacturing a light guide plate pattern on a blank light guide plate, wherein the light guide plate pattern comprises a plurality of protrudent dot patterns, the method comprising following steps:
providing the blank light guide plate;
progressing a protrudent dot treatment process on a light guide plate surface of the blank light guide plate, the protrudent dot treatment process using a protrudent dot processing device filled with a protrudent dot material to sequentially form the protrudent dot patterns on the light guide plate surface individually by utilizing the protrudent dot material; and
solidifying the protrudent dot patterns to finish defining the light guide plate pattern on the light guide plate surface.

12. The method of claim 11, wherein the protrudent dot treatment process is a dispensing process, and the protrudent dot processing device is a dispensing machine.

13. The method of claim 11, wherein the method further comprises replacing a dispensing nozzle of the dispensing machine or adjusting dispensing pressure or timing to form the protrudent dot patterns after a part of the protrudent dot patterns are formed.

14. The method of claim 11, wherein the protrudent dot treatment process is an inkjet process, and the protrudent dot processing device comprises a sprinkling nozzle; when forming each of the protrudent dot patterns, the sprinkling nozzle is utilized to directly sprinkle the protrudent dot material on the blank light guide plate to form the protrudent dot pattern.

15. The method of claim 11, wherein the protrudent dot patterns are classified to at least a first pattern and a second pattern according to size, surface roughness, or shape, and the protrudent dot treatment process comprises forming each protrudent dot pattern of the first pattern on the light guide plate surface first, and then forming each protrudent dot pattern of the second pattern.

16. The method of claim 11, wherein the method further comprises progressing a process parameter adjustment for the protrudent dot processing device after each protrudent dot pattern of the first pattern is formed.

17. The method of claim 11, wherein the protrudent dot material comprises photosensitive resin or ink.

18. The method of claim 1, wherein the wherein the protrudent dot treatment process further comprises a surface roughening process for the protrudent dot patterns.

19. The method of claim 18, wherein the surface roughening process provides a variation of energy or temperature for the protrudent dot patterns to destroy surface tension of the protrudent dot patterns.

20. The method of claim 19, wherein the surface roughening process comprises a sputtering process or a heating process.
